(19) United States
(12) Patent Application Publication
(10) Pub. No.: US 2003/0131935 A1
(43) Pub. Date: Jul. 17, 2003

(54) Apparatus and method for bonding facing to insulation

(76) Inventor: Dave Van Dyne, Kansas City, MO (US)

Correspondence Address: SWANSON MIDGLEY, LLC, Suite 400, 2420 Pershing Road, Kansas City, MO, 64108-2505, US

(21) Appl. No.: 10/047,130

(22) Filed: Jan. 15, 2002

(51) Int. Cl. B32B 31/04

(52) U.S. Cl. 156/308.2; 156/324; 156/543

(57) ABSTRACT

Production machinery applies heat fusible protective films to fibrous insulation rolls or batts. The insulation is passed through a conveyor with upper and lower conveyor belts which pinch the insulation therebetween and which urge protective films into contact. The conveyor belts are heated by proximate heater apparatus to a sufficiently high temperature to cause the film to become tacky and bond to the insulation.

### FIELD OF THE INVENTION

This invention relates to production of fiberglass or rolls and particularly to such insulative material which is faced with a protective layer applied to the material.

### BACKGROUND OF THE INVENTION

Mineral fiber or fiberglass insulation rolls or batts are old and well known and have long been coated or backed with vapor barrier materials such as kraft paper or plastic films. Typically, the base mineral fiber insulation is processed along an endless conveyor system and a sheet or sheets of kraft paper are adhered to one or opposite surfaces of the insulation. In a typical production system, the kraft paper is joined to the insulation by an adhesive process.

U.S. Pat. No. 5,362,539 discloses a mineral fiber batt coated with a polyethylene film. Either an adhesive, Velcro, hook and loop strips or heat sealing is used to adhere the vapor permeable polyethylene film to the mineral fiber core. With respect to the use of an adhesive or Velcro to attach the polyethylene to the mineral core, there are multiple step adhering processes for coating the batt with the film. They are undesirable and inefficient and make a production process uneconomical.

U.S. Pat. No. 5,277,955 discloses a mineral fiber batt coated with a polyethylene layer. The polyethylene layer may be heated to join the film to the batt. The '955 patent advises using an additional adhesive layer or strip to connect the film to the batt. The use of an adhesive layer or strip is also an additional manufacturing step.

U.S. Pat. No. 5,746,854 discloses encapsulating an insulation batt by sandwiching the batt between upper and lower meltable films of polyethylene. The polyethylene is heated to tackiness by a heated drum or roller which provides surface contact over a relatively small portion of the circumference of the drum. Unfortunately, the system disclosed in the '854 patent provides a short dwell time to heat and partially melt the polyethylene film to a state of tackiness and bonding contact. The longer the desired dwell time, the larger the roller must be made, to the effect that to bond sufficiently, a very large and cumbersome roller must be used. These features are considered less than desirable.

In view of the above, it is clear to those of skill in the art that a need exists for an improved method of bonding a protective facing to a fibrous insulation roll or batt so that the machinery of the production process is compact, easy to service and maintain, sufficiently bonds the facing film to the insulation and does so without the use of adhesives or other methods that are service intensive and prone to clogging and other downtime.

### OBJECTS OF THE INVENTION

The objects of the present invention are:

a) to provide production machinery for applying a protective facing to an insulation roll or batt;

b) to provide such production machinery which evenly and securely bonds a protective plastic film to rolls or batts of fibrous insulation material;

c) to provide such production machinery and a method for its use which bonds polyethylene film to fibrous insulation without using slow and maintenance intensive methods such as adhesive application; and

d) to provide such production machinery and methods of use which are compact and economical to produce yet achieve the desired purpose of economically and efficiently applying a protective polyethylene film to fiberglass insulation.

Other objects and advantages of the present invention will become apparent from the following description taken in connection with the drawings.

### SUMMARY OF THE INVENTION

The present invention is directed to production machinery for applying a heat fusible protective film to insulative mineral or glass fiber rolls or batts or other insulation material. As used herein, the term “film” applies to a thin layer of a protective facing such as kraft paper or plastic film, and including other such materials that may be effectively used as vapor barriers or protective barriers keeping the insulation intact. The insulation is passed through a conveyor having at least one conveyor belt and the protective film is urged into contact with the insulation roll or batt. The conveyor belt is heated by a proximate heater apparatus to a sufficiently high temperature to cause the film to become tacky and bond to the insulation. A preferred embodiment of the invention carries the insulation between upper and lower conveyor belts which press the protective films into contact with the insulation. Both upper and lower conveyor belts are heated so that the insulation is bonded to the insulation on top and bottom faces.

### DESCRIPTION OF THE DRAWINGS

FIG. 1 is a perspective view of the production machinery according to the present invention.

FIG. 2 is a side elevational view of the production machinery.

FIG. 3 is an end elevational view of the production machinery.

FIG. 4 is an enlarged fragmentary view of the conveyor members.

FIG. 5 is an enlarged cross-sectional view taken along lines 5-5, FIG. 4.

### DESCRIPTION OF THE PREFERRED AND ALTERNATE EMBODIMENTS

As required, detailed embodiments of the present invention are disclosed herein, however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

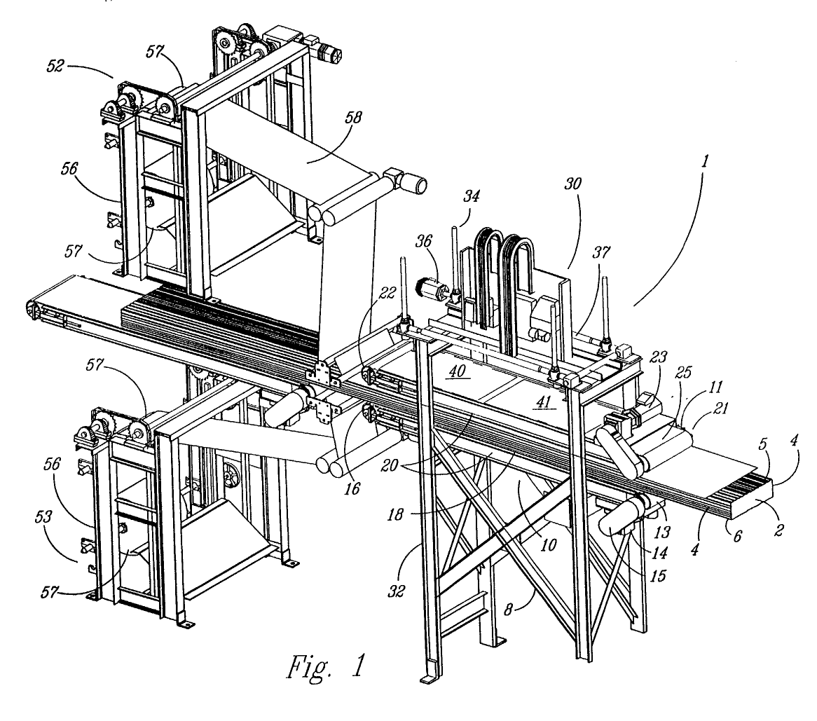

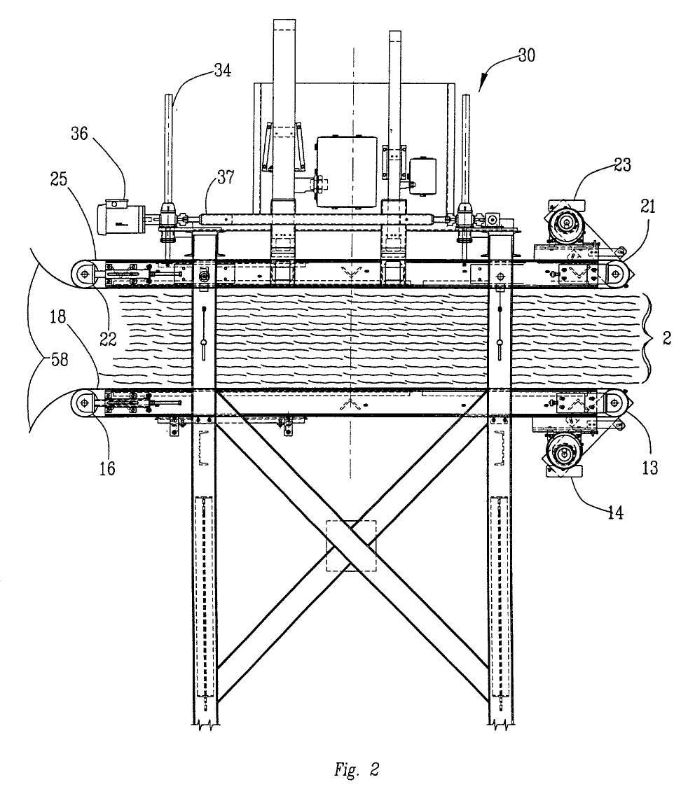

The reference numeral 1, FIG. 1, generally designates production machinery which applies heat fusible films to fibrous insulation rolls or batts. The insulation 2 includes mineral fiber as well as fiberglass. Although the primary use for the production machinery 1 is seen to be for applying a barrier facing to insulation rolls or batts, other uses not involving insulation may be possible. For example, it may be used to apply a barrier facing to cardboard web or other such backing that is not intended to have primary use as insulation. Typically, insulation rolls or batts are manufactured in a long, continuous length and the production machinery 1 is intended to be a station in the manufacturing process wherein the preformed length of insulation is faced with protective films. Downstream of the production machinery 1, the faced insulation is prepared for shipment to consumers in either the form of large rolls of insulation or by cutting into batts of, for example, 4′ to 8 feet long. The continuous length of insulation 2 is typically 15-24 inches wide and 3-12 inches thick, the thickness of the insulation material rendering an R value which indicates its insulative value or resistance to heat loss. Fibrous insulation is subject to shedding fibers when handled during installation. It is desirable to face, or apply a film to at least one side of the insulation to provide a vapor barrier and to prevent shedding of the fibers, which can cause irritation to the skin or eyes of the installer. Additionally, the facing used on the insulation may extend sidewardly of the insulation and provide a nailing strip for installation. As the insulation arrives at the production machinery 1, it is configured to have opposite side surfaces 4 and top and bottom faces 5 and 6.

The production machinery 1 includes support structure 8 consisting of legs and braces which elevate working mechanisms of the machinery 1 above a floor surface and in line with the remainder of conveying surfaces moving the insulation 2 from the insulation forming process to the production line termination. The production machinery 1 includes in major part conveyors which form a conveyor section in the production machinery line of conveyors. In the illustrated example, the machinery shown in FIG. 1 includes a bottom conveyor 10 and an upper conveyor 11. Each has a longitudinally extending belt. The bottom conveyor is driven by a powered end roller 13 mounted between side rails 12 and rotated by a motor 14 through a drive belt 15. An opposite end roller 16 is a free roller. A continuous belt 18 travels between the rollers 13 and 16 and forms the conveying surface for the bottom conveyor 10. The conveyor belt 18 must be heat conductive yet sufficiently robust so that it does not deteriorate under heat. Suitable belts 18 include those that are formed with glass fibers and coated with Teflon, although other forms of belts may meet the criteria for use.

The top conveyor 11 is similar to the bottom conveyor 10 and includes side rails 20 supporting opposite end rollers 21 and 22, the end roller 21 being belt driven by a motor 23. A conveyor belt 25 is driven by the powered end roller 21 and forms the upper or top conveying surface. The bottom conveyor 10 is fixed in position on the support structure 8 whereas the top conveyor 11 is mounted above the bottom conveyor 10 so as to be variable in height to accommodate different thicknesses of insulation material run between the conveyors. To provide height variability, the support structure 8 extends above the bottom conveyor 10 and mounts an upper variable height mechanism 30 which in the illustrated example, consists of vertical guide members 32 and spaced jack screws 34 driven by a motor 36. A rotary link 37 connects the spaced jack screws 34 for level raising and lowering. Ideally, the variable height mechanism includes four jack screws, one at each corner of the rectangular arrangement of the top conveyor 11, all linked together by various shaft rotary links 37. Preferably, the variable height mechanism 30 provides significant vertical travel such as approximately 25″ in order to raise sufficiently high for maintenance access.

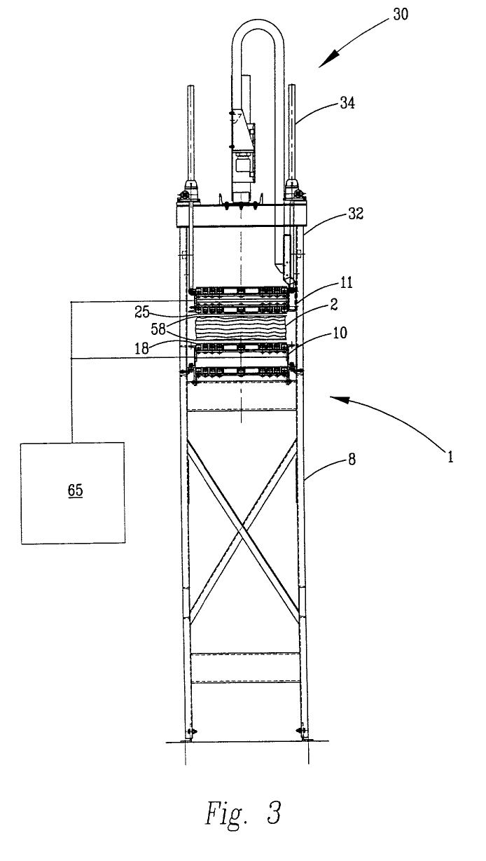

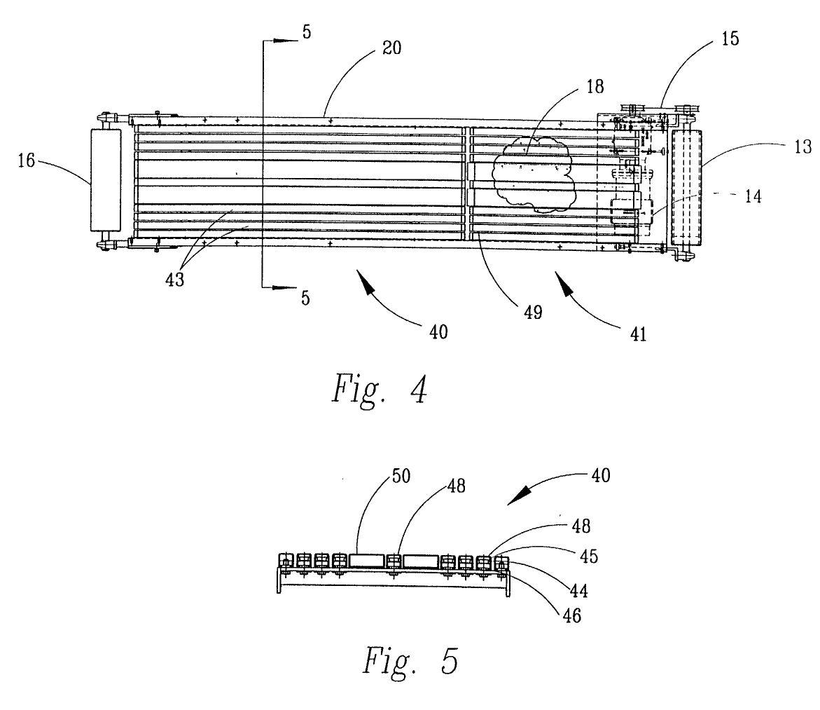

Each of the top and bottom conveyors 10 and 11 include heating and cooling arrays. Referring to FIG. 4, each of the conveyors 10 and 11 first consists of a heating section 40 followed downstream by a cooling section 41. Within the heating section 40 are a plurality of heater strips 43, each heater strip consisting of an electrical resistance element 44 mounted against a core strip and contained within an elongate housing platen 48. The platen 48 is mounted to conveyor support structure by mounting posts 46. As shown in the end view, FIG. 3, each of the bottom and top conveyors 10 and 11 consists of a center platen 48 bracketed by elongate box like sliding surfaces 50 further bracketed by a series of additional platens 48, such as three on each side of centerline as shown in FIG. 5. The platens 48 and filler strips 50 provide a level surface on which the respective conveyor belt 18 or 25 slides as it conveys insulation material. The heater strips 43 in the illustrated embodiment are electrically heated although other heater means may be employed and still be within the scope of the present invention. Other acceptable means include recirculating hot fluids or gases. Ideally, the heater strips 43 are regulated to provide a constant temperature suitably above the softening temperature of the film and delivered to the respective belt 18 or 25. Temperature loss is expected in the belt and the desired temperature to maintain in the belt is the softening temperature in order to impart sufficient heat into the film and insulation as it travels on the belt in order to raise it to a fusing temperature.

A cooling section 41 is provided downstream of the heating section 40 and consists of a like assemblage of platens 48 and sliding surfaces 49 with the exception that in the cooling section 41, the platens 48 are empty shells and do not have internal heating means. The platens 48 in the cooling section 41 may further include additional cooling means to provide a more rapid heat sink such as recirculating liquids or air to pull off temperature build up. The cooling section 41 pulls heat from the heated insulation to reduce the temperature in the film and insulation so that the materials are bonded together and no longer tacky or sticky. Preferably, temperature controllers (not shown) are connected into the heater strips 43 so as to maintain a set desired temperature in the heating section 40. Preferably the temperature controllers are interconnected to a PLC 65 which is programmed so that temperature can be individually regulated in individual heater strips 43. This ability provides the manufacturer with the ability to cause differences in the extent of bonding between the facing material and the insulation. The manufacturer may desire less bonding along a centerline of the insulation and more along the edges, which can be accomplished by the disclosed apparatus. In an actual embodiment, the heating section 40 is approximately 6′ long and the cooling section 41 is approximately 3 ½′ long. The length of the heating section 40 provides sufficient dwell time under heat to cause the film material to become partially melted and tacky in order to bond with the insulation fibers.

FIG. 1 discloses an exemplary layout of a film feed apparatus for routing sheets of film into contact with the surfaces of the insulation 2. In the illustrated example, the production machinery is set up to apply film on both the top face 5 and bottom face 6 of the insulation 2 by including an upper film feeder 52 and a lower film feeder 53. Each of the film feeders 52 and 53 are substantially identical and contains support structure 56 holding rolls 57 of film material 58. The film is drawn onto the insulation material as it travels between the conveyors 10 and 11. Various films may be applied using the production machinery 1, the criterion of the film being that it must have a heat fusible component so that it will bond to the insulation fibers. An example of a suitable film with heat fusible component is an olefin polymer having a peak melting temperature of 197° F. Alternatively, the film may be a polycoated facing or may be an asphalt coated facing such as kraft paper. The film may be applied to either or both the top face 5 and bottom face 6 of the insulation 4. Additional machinery may be arranged downstream of the production machinery 1 to edge seal excess film material extending from the top and bottom faces 6 and form a nailing strip or directly seal the excess film to the insulation side surfaces 4. The top conveyor 11 is brought down into pinching or compressing contact with the insulation 4 as the insulation is fed between the top and bottom conveyors 11 and 10 to apply pressure via the respective conveyor belts 18 and 25 to press the tacky film into bonding contact with the insulation fibers. The downward travel of the top conveyor 11 is adjusted to provide appropriate pressure for varying thicknesses of insulation 4.

It is to be understood that while certain forms of the present invention have been illustrated and described herein, it is not to be limited to those specific forms or arrangement of parts described and shown except in as so far as set forth in the following claims.

What is claimed and desired to be protected by Letters Patent is:

1. Machinery for applying a cover layer which is at least partially fusible to a length of insulation material comprising:
a. conveyor apparatus for transporting the insulation material, said conveyor apparatus including a revolving, heat-conductive belt extending longitudinally planar;
b. cover layer feeder apparatus for positioning the cover layer between the belt and the insulation material; and
c. heater apparatus proximate to the belt so as to transfer heat through the belt to cause the cover layer to at least partially fuse and adhere to the insulation material.

2. The machinery set forth in claim 1 wherein said belt is a conveyor belt transporting the insulation material laid atop said belt with said heater apparatus mounted below said belt.

3. The machinery set forth in claim 2 wherein said heater apparatus is an electrical resistance heater.

4. The machinery set forth in claim 3 wherein said heater apparatus comprises a plurality of elongate strips of electrical resistance heaters mounted between metal platen strips.

5. The machinery set forth in claim 4 wherein said strips of electrical resistance heaters are individually connected to temperature controllers for individually setting the temperatures thereof.

6. Machinery for applying a cover layer which is at least partially fusible to a length of insulation material, comprising:
a. conveyor apparatus for transporting the insulation material, said conveyor apparatus including upper and lower revolving, heat conductive belts with said insulation material squeezed between the upper and lower belts;
b. cover layer feeder apparatus for positioning cover layers on opposite sides of the insulation material and between the upper and lower belts;
c. heater apparatus proximate to the upper and lower belts so as to transfer heat through the belts to cause the cover layers to at least partially fuse and adhere to respective upper and lower sides of the insulation material.

7. A method for applying a cover layer which is at least partially fusible comprising the steps of:
a. conveying said layer of insulation material on a conveyor belt;
b. applying a cover layer between the insulation material and the conveyor belt; and
c. applying heat to said conveyor belt sufficient to at least partially fuse the cover layer and cause same to adhere to the insulation material.

8. A method for applying a cover layer which is at least partially fusible to a length of insulation material comprising steps of:
a. conveying said layer of insulation material pinched between upper and lower conveyor belts;
b. applying cover layers between surfaces of the insulation material and the upper and lower conveyor belts; and
c. applying heat to the conveyor belts sufficient to at least partially fuse the cover layers and cause same to adhere to the insulation material.
